(19) United States
(12) Patent Application Publication
(10) Pub. No.: US 2002/0153518 A1
(43) Pub. Date: Oct. 24, 2002

(54) Base for a strap tightener

(76) Inventor: Chi-San Huang, Changhua City (TW)

Correspondence Address: Cooper & Dunham LLP, 1185 Avenue of the Americas, New York, NY, 10036, US

(21) Appl. No.: 09/837,718

(22) Filed: Apr. 18, 2001

(51) Int. Cl. B66F 3/00

(52) U.S. Cl. 254/223

(57) ABSTRACT

A base for a strap tightener includes a base plate having one edge bent to form a hook. Two wing plates are vertically formed on the base plate and each has a first end toward the hook and a second end. An end plate extends perpendicular from the first end of one of the two wing plates toward the other wing plate, and a through hole is defined in the end plate. A hole is defined in the second end of each wing plate and the edge of the second end of the wing plates is round and corresponds to the shape of the hole. A stop extends from the second end of the wing plate and a groove is defined in the stop. All the elements of the base are integrally formed on a base plate to save material and shorten the manufacturing time.

### BACKGROUND OF THE INVENTION

1. Field of the Invention

The present invention relates to a base, and more particularly to a base for a strap tightener. The base for a strap tightener in accordance with the present invention is formed integrally from a single piece of metal.

2. Description of Related Art

With reference to FIG. 4, a conventional base for a strap tightener in accordance with the prior art comprises a base plate (50) and a U-shaped seat (60) mounted on the base plate (50). The seat (60) is adapted to mount a lever (C) and a pivot pin (B) assembled as a strap tightener.

The base plate (50) has a distal edge and a proximal edge parallel to each other. The distal edge of the base plate (50) is bent to form a hook (500). A slot (52) is defined in the base plate (50) near the proximal edge through which a strap can pass. A pair of ears (51) extends perpendicular from the base plate (50) in a direction opposite to the hook (500). The slot (52) corresponds to the pair of ears (51) and is parallel to the distal edge of the base plate (50). Each of the ears (51) has a through hole (511) defined to align with the through hole (511) in the other ear (51). A bore (53) is defined in the base plate (50) between the pair of ears (51) and the slot (52).

The seat (60) includes two wing plates (600) parallel to each other and connected by a bridge (601) to form a U-shape. A positioning plate (602) extends upward from one side of the bridge (601) near the pair of ears (51), and a hole (604) is defined in the positioning plate (602). A through hole (61) is defined in one end of each wing plate (600) to correspond to the through holes (511) in the ears (51). A through hole (603) is defined in the bridge (601) and corresponds to the bore (53) in the base plate (50). The through holes (61) in the wing plate (600) align with the through holes (511) in the ears (51) after a first bolt (700) extends through the bore (53) in the base plate (50) and the through hole (603) in the bridge (601). The first bolt (70) and the seat (60) are held in place be a first nut (700) screwed onto the first bolt (70). A second bolt (80) extends through the through holes (511, 61) in the ears (51) and the wing plates (600). A second nut (800) is screwed onto the second bolt (80) to secure the seat (60) on the base plate (50).

A ratchet device (A), a pivot axle (B) and a lever (C) are attached to the seat (60) to be able to tighten a strap and securely hold an object in place. However, the base for a strap tightener in accordance with the prior art still has several disadvantages.

1. The base plate (50) and the seat (60) are manufactured separately. It wastes material.

2. The base plate (50) and the seat (60) are connected by at least two bolts (70, 80). The worker assembling the conventional device must spend time screwing the nuts (700, 800) onto the bolts (70, 80) so that the manufacturing rate is reduced.

The present invention has arisen to mitigate and/or obviate the disadvantages of the conventional base for a strap tightener.

### SUMMARY OF THE INVENTION

The main objective of the present invention is to provide an improved base for a strap tightener fabricated with all the element of the base integrally formed on a base plate to save material and shorten manufacturing time.

Further benefits and advantages of the present invention will become apparent after a careful reading of the detailed description with appropriate reference to the accompanying drawings.

### BRIEF DESCRIPTION OF THE DRAWINGS

FIG. 1 is a top plan view of a base in accordance with the present invention for a strap tightener after cutting or stamping and before being bent into its final form;

FIG. 2 is a perspective view of the base for a strap tightener in accordance with the present invention;

FIG. 3 is an exploded perspective view of the base in FIG. 2 as a part of a strap tightener; and

FIG. 4 is a partially exploded perspective view of a conventional strap tightener in accordance with the prior art.

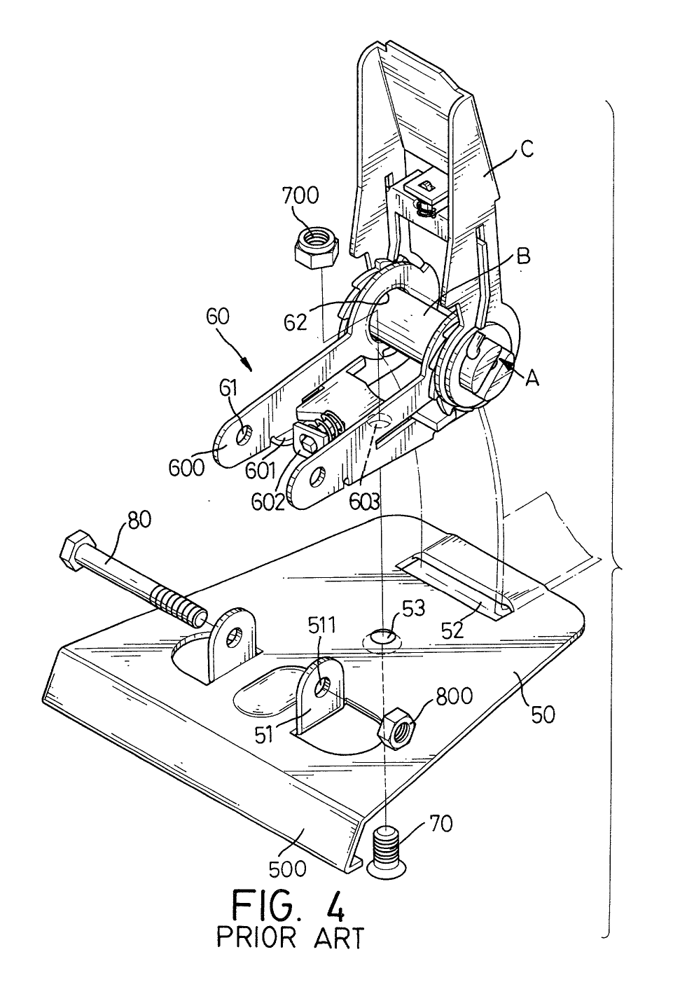

### DETAILED DESCRIPTION OF THE INVENTION

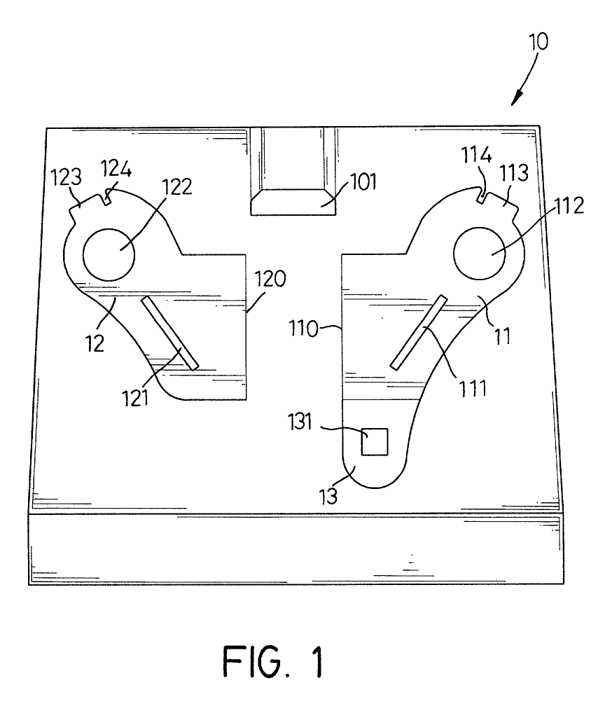

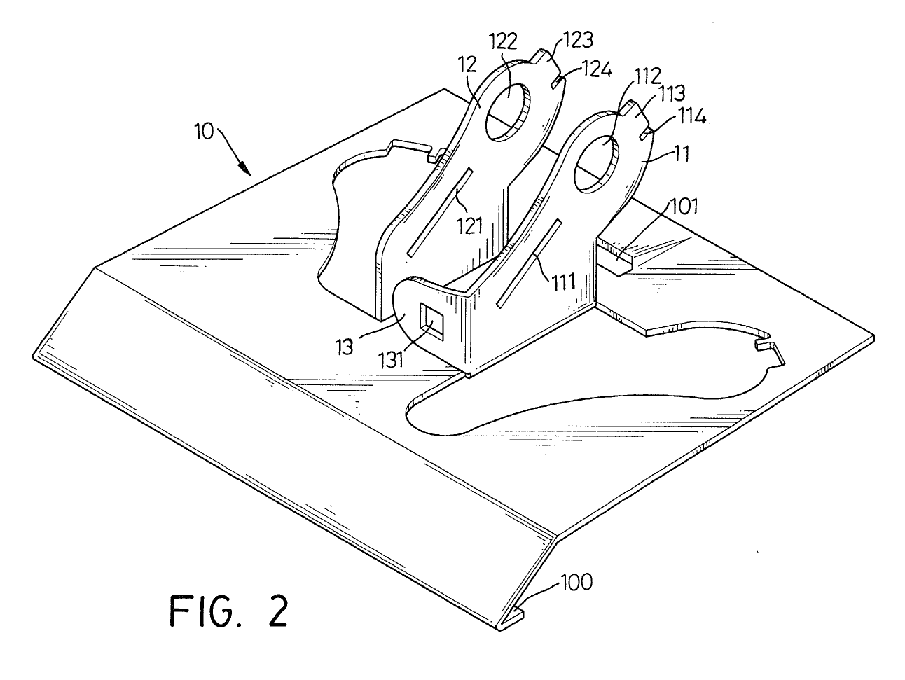

With reference to the drawings and initially to FIGS. 1 and 2, a base in accordance with the present invention for a strap tightener comprises base plate (10) having a distal edge bent to form a hook (100) and a proximal edge. A strap slot (101) is defined in the base plate (10) parallel to the distal edge near the proximal edge of the base plate (10). A first wing plate (11) and a second wing plate (12) are formed in the base plate (10) by laser cutting to have a curved distal edge and a straight proximal edge. The straight proximal edge has one end near and perpendicular to the distal edge of the base plate (10) and another end near and perpendicular to the proximal edge of the base plate (10). The wing plates (11, 12) are bent upward to be perpendicular to the base plate (10). The curved end of the two wing plates (11, 12) near the proximal edge of the base plate (10) is higher than the curved end two wing plates (11, 12) near the distal end of the base plate (10). An end plate (13) extends perpendicular from the end of one of the two plates (12) near the distal end of the base plate (10) and toward the other wing plate (11). A through hole (131) is defined in the end plate (13). Aligned holes (112, 122) are defined in the end of the wing plates (11, 12) near the proximal edge of the base plate (10). The edge of the end of the wing plates (11, 12) near the proximal edge of the base plate (10) is round and corresponds to the shape of the holes (112, 122). A second slot (111, 121) is defined in each wing plate (11, 12) between the end of the wing plate (11, 12) near the distal end of the base plate (10) and the holes (112, 122) in the wing plates (11, 12). A stop (113, 123) extends from the higher end of the wing plate (11, 12) and a groove (114, 124) is defined in the stop (113, 123).

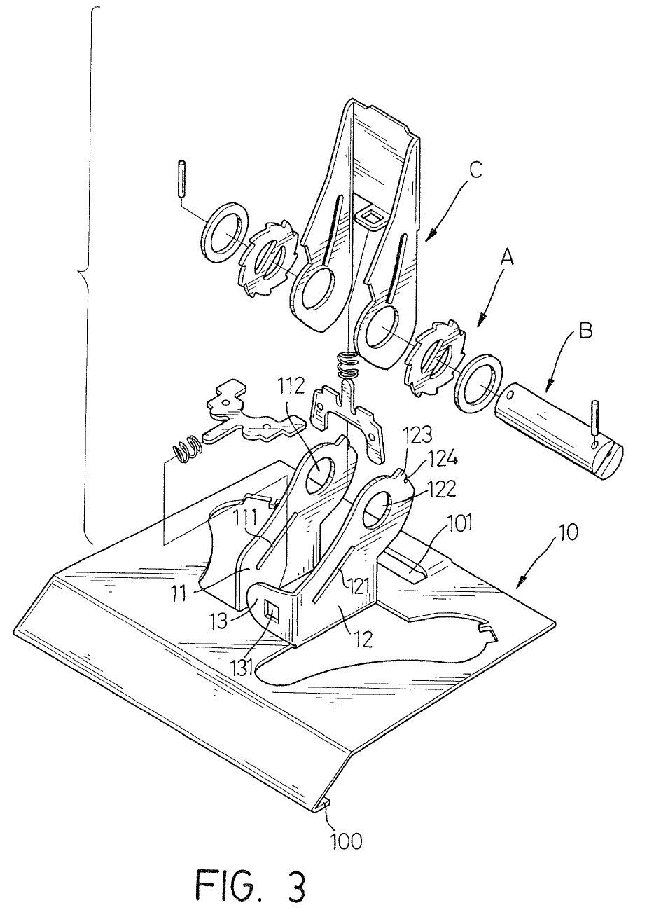

With reference to FIG. 3, a ratchet device (A), a pivot axle (B) and a lever (C) are respectively mounted on the base to form a strap tightener.

The base for a strap tightener as described has the following advantages.

1. The base for a strap tightener is formed from a single plate so that material is saved and waste material is greatly reduced.

2. The entire manufacturing process can be automated to promote the manufacturing rate.

3. No bolts and nuts are used so the assembl process is simplified and the maker does not need time to assemble the base.

Although the invention has been explained in relation to its preferred embodiment, it is to be understood that many other possible modifications and variations can be made without departing from the spirit and scope of the invention as hereinafter claimed.

What is claimed is:

1. A base for a strap tightener comprising:
a base plate having a distal edge bent to form a hook and a proximal edge;
a first wing plate and a second wing plate formed on the base plate and bending perpendicular to the base plate, each of the first and second wing plates having a first end toward the distal edge of the base plate and a second end opposite to the first end toward the proximal edge of the base plate, the second end of the first and second wing plates having a height higher than a height of the first end of the first and second wing plates relative to the base plate;
an end plate extending perpendicular from the first end of one of the first and second wing plates toward the other wing plate, and a through hole defined in the end plate;
a hole defined in the second end of each wing plate, the hole adapted to pivotally receive an axle to hold a ratchet device and a lever in place, the edge of the second end of the wing plates being round and corresponding to the shape of the hole; and
a stop extending from the second end of the wing plate and a groove defined in the stop, the stop adapted to hold the lever in place.

2. The base for a strap tightener as claimed in claim 1, wherein a slot is defined in the base plate near the second end of the base plate to allow the strap pass through.
